(19) United States
(12) Patent Application Publication
(10) Pub. No.: US 2008/0270544 A1
(43) Pub. Date: Oct. 30, 2008

(54) GREYLISTING OPTIMIZATIONS FOR ELECTRONIC MAIL FILTERING

(76) Inventor: Anthony C. Howe, Cannes (FR)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/741,514

(22) Filed: Apr. 27, 2007

(51) Int. Cl. G06F 15/16

(52) U.S. Cl. 709/206

(57) ABSTRACT

The present invention is directed to providing mail system administrators with the ability to choose the members of a key set used for storage and retrieval of greylisting records, wherein the key set members are derived from information concerning an SMTP transaction, such as SMTP client network details and/or other SMTP command arguments in addition to those of MAIL FROM: and RCPT TO:. The invention is further directed to the specific treatment of a key set that uses a client PTR record obtained from a DNS query based on an IP address of a connected SMTP client.

### FIELD OF THE INVENTION

This invention broadly relates to the filtering of electronic mail messages (email), and more particularly, to the filtering email using modified greylisting methods.

### BACKGROUND OF THE INVENTION

The Internet is a massive communications medium that provides its users with a convenient, fast, and inexpensive means to send email messages to other users around the globe. In many cases, the Internet has replaced the physical delivery of mail by the postal service. As result of its popularity, advertisers have turned to using email as a way to promote products with unsolicited commercial or bulk email. In addition, online thieves frequently take advantage of the email system to steal information using email borne worms and viruses. Undesirable junk email messages from these sources are often collectively referred to as “spam”.

The problem of spam has escalated to pandemic proportions and threatens every email provider's ability to deliver regular email to their users, consuming time and resources to correct. As a result, many email providers deploy policy, behavioral, and/or content based filtering methods on their mail systems.

The original greylisting (OGL) method is a behavioral filter that takes advantage of SMTP procedures defined in RFC 2821 by temporarily rejecting email from an unknown source in order to determine if that source implements a retry queue. This method is based on an assumption that junk mail systems are typically implemented with speed and volume in mind, rather than reliability. As such, junk mail systems do not utilize mail retry queues. If email from a previously refused source returns within a certain time frame, then it may be permitted to pass.

There are several drawbacks of using the OGL method. One drawback is that some legitimate sending sites (e.g., gmail.com) use a pool of mail servers with a shared mail queue, such that mail queue retries appear to come from constantly changing IP addresses. This has a negative impact on recipient sites using the OGL key set of {client-IP, sender, recipient}. A receiving site using OGL constantly sees a different client IP address, but with the same sender and recipient. The use of OGL may result in the receiving site greylisting and delaying a good message multiple times, and may result in the message not being delivered.

Another drawback of using the OGL method concerns additional and unnecessary greylisting delays. As an anti-spam technique, greylisting asks a single question: does the sending mail server implement a mail retry queue? Many conventional greylisting implementations cache each and every unique {client-IP, sender, recipient} key set, and only allow repeat visits from the same key set to pass without delay. However, once it is determined that a sending mail server implements a retry queue, new mail from the same machine, but from different senders and/or to different recipients, may be exposed to additional and unnecessary greylisting delays.

Some greylisting implementations have attempted to address the above-identified issues. For example, one known technique converts the cached key set of a successful connection from {client-IP, sender, recipient} to {client-IP/24}, i.e., white list all the machines in the /24 subnet of which the client IP is a member. While this may resolve both drawbacks mentioned above, the assumption is too broad and imprecise. It is often the case that unrelated mail sources share the same net block, since Internet providers no longer assign a whole /24 subnet to each customer they host. Instead, IP/24 addresses are rationed out in smaller subnets. Frequently, spam sources appear as neighboring machines within the same /24 subnet. The OpenBSD greylisting implementation takes a more conservative view by converting a successful cached key set to just the {client-IP} of the machine that is known to implement a retry queue. This will solve the drawback of unnecessary delays, but it doesn't address the problem concerning mail server pools with changing IP addresses.

### SUMMARY OF THE INVENTION

The present invention addresses the problem of repeated delays in the delivery of electronic mail, primarily from network mail systems that use a pool of mail servers sharing a mail queue. In particular, the invention provides mail system administrators with the ability to choose the members of the key set used for storage and retrieval of greylisting records. These key set members are derived from information concerning the SMTP transaction, such as SMTP client network details and/or SMTP command arguments in addition to those of MAIL FROM: and RCPT TO: already used in OGL. The use of different key sets has a varying effect on how greylisting behaves. The invention also addresses the specific treatment of a key set that uses a client PTR record obtained from the domain name system (DNS) based on the IP address of the connected SMTP client. The client PTR record is used to map IP addresses to host names, and allows for a key set of the form {trimmed-PTR, sender, recipient}.

According to the invention, the greylisting record is stored and retrieved by a key using a set of configurable attributes (members) related to known and/or derivable details of the email transaction. The configurable members that can comprise the key set are: (a) SMTP client network information known and/or derived from the connected client IP address and connection details (such as IP address or subnet, passive OS finger-printing, PTR records, NS records, AS numbers, WHOIS data); (b) sender information derived from a MAIL FROM: argument (such as the email address, domain name, MX records, NS records, TXT records, WHOIS data); (c) recipient information derived from each RCPT TO: argument (such as the email address or domain name); and (d) other SMTP command arguments in whole or in part (such as HELO or EHLO arguments, AUTH arguments, and STARTTLS details). The {IP subnet specification}, {client IP address, MAIL FROM: address, RCPT TO: address}, and the empty (null) sets represent known key sets used in prior art and a preferred embodiment of the invention may still include them for completeness and the variety of choice offered a mail system administrator.

In accordance with the principles of the invention, a method for greylisting a message of an SMTP transaction in response to a RCPT TO: (or DATA) command from an SMTP client, comprises the steps of: (a) looking up in a storage medium a key set having pre-selected members; (b) if the key set is not found, adding a new record comprising a key set and a timestamp value of when the record was added, then replying to a RCPT TO: command with a temporary failure result; (c) if the key set was found in step (a), but the predetermined greylist period has not expired, then replying to a RCPT TO: command with a temporary failure result; and (d) replying to the RCPT TO: command with an OK result if the key set is found in step (a) and the predetermined greylist period has expired.

According to the invention, when one of the pre-selected members of the key set include a “trimmed-PTR”, an additional method for greylisting a message of an SMTP transaction in response to a RCPT TO: (or DATA) command from an SMTP client, comprises the steps of: (a) determining whether a client PTR record exists and is suitable for use; (b) if the client PTR record exists and is suitable to use, trimming the host name of a machine given by the client PTR record by removing a leading label, only when the host name is not the same as the domain name, otherwise using the client IP address as a default value; (c) looking up in a storage medium a key set containing only the {trimmed-PTR} or the {client-IP}; (d) if a result from step (c) is found, continue at step (g); (e) looking up in storage medium the key set containing the trimmed PTR record or the client IP address in addition to the other preselected members; (f) if the key set is not found, adding a new record comprising a key set and a timestamp value of when the record was added and replying to a RCPT TO: command with a temporary failure result; (g) if a key set is found in steps (c) or (e) and if a predetermined greylist period has not expired, then reply to a RCPT TO: command with a temporary failure result; otherwise (h) the predetermined greylist period for that key set has expired, reduce the key set to the {trimmed-PTR} set or {client-IP} set, and replying to the RCPT TO: command with an OK result.

The above-described methods can also be applied in response to the SMTP DATA command instead of each RCPT TO: command. If the key set does not contain a recipient member or members derived from a recipient, then the method is the same as above. Otherwise the method is repeated for each recipient, replying CONTINUE to the DATA command for the first key set that is found and has passed the predetermined greylist period. Otherwise all the key sets have failed to be found or have not yet passed the predetermined greylist period, so only then is a temporary failure result sent in response to the DATA command.

The client PTR record is not suitable for use if it is multi-homed and the resulting list of host names maps to multiple domain names, or if the host name is composed from parts of the client IP address typically assigned by ISPs to residential or dynamic IP blocks. According to some embodiments, the client PTR record is not suitable for use if an SPF check results in a Fail or SoftFail. In accordance with the principles of the invention, trimming the PTR record permits an identification of a group of mail servers by a common domain or subdomain name. A key set containing the trimmed PTR record may be of the form {trimmed-PTR, sender, recipient}. Other key sets containing the trimmed PTR and other configurable members are also possible without departing from the scope of the invention.

### BRIEF DESCRIPTION OF THE DRAWINGS

FIG. 1 (prior art) is a schematic diagram illustrating a conventional SMTP transaction without greylisting;

FIG. 2 prior art) is a schematic diagram illustrating an SMTP transaction using the original greylisting method;

FIG. 3 is a schematic diagram illustrating the logic sequence of the SMTP transaction of FIG. 2 using a modified greylisting method with a key set of preconfigured members in place of the set used by OGL, in accordance with the principles of the invention; and

FIG. 4 is a schematic diagram illustrating the logic sequence of the SMTP transaction of FIG. 2 using another modified greylisting method where the key set contains a “trimmed-PTR” member, in accordance with the principles of the invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Before starting a description of the Figures, some terms will now be defined.

AS=Antonymous System number used in network routing

DNS=Domain Name System, a general-purpose distributed data query service used on the Internet for translating hostnames into Internet addresses and related information.

MTA=Mail Transfer Agent for handling routing and delivery of mail from a local site to one or more remote sites.

OGL=Original Greylisting as outlined by Evan Harris.

PTR Record=a reverse-lookup pointer record in DNS that maps an IP address to a host name.

SMTP=Simple Mail Transfer Protocol, as defined by RFC 2821.

SPF=Sender Policy Framework, as defined by RFC 4408.

Blacklisting is a method of defending electronic mail users against e-mail spam using blacklists of known spammers, their IP addresses, and/or their ISP. Using this information, spam filters can block all messages coming from known spammers and/or their ISPs.

Greylisting is a method of defending electronic mail users against e-mail spam, wherein an MTA “temporarily rejects” any email from a sender it does not recognize. If the mail is legitimate, the originating server will try again to send it later, at which time the destination will accept it. However, if the mail is from a spammer, it will probably not be retried.

Whitelisting is a method used to permit selected IP addresses, email addresses, or domain names to circumvent blacklisting, greylisting, or other filtering methods that might result in desired email being rejected, discarded, or quarantined.

The present invention is directed to a greylisting method that offers a mail system administrator the ability to choose the members that define a key set used for storage and retrieval of greylisting records. The members may be derived from information concerning the SMTP transaction, such as SMTP client network details (such as client PTR information found using a DNS lookup for a PTR record, which is used to map an IP address to a client host name) and/or SMTP command arguments in addition to those of MAIL FROM: and RCPT TO: already used in OGL.

According to the invention, various types of members may be selected by the mail system administrator including, but not limited to: (a) the client IP address and derivative information such as the client IP subnet, client PTR information, NS records of the client's network provider, AS numbers for the client's network provider, WHOIS data of the client's network provider, and passive OS finger-printing of network traffic from the client; (b) SMTP command arguments such as either the HELO or EHLO argument, AUTH arguments, STARTTLS certificate details; (c) the MAIL FROM: argument (sender), the sender's domain name and derivative information like the MX records, NS records, TXT records, and WHOIS data about the domain name; (d) the RCPT TO: argument (recipient) and recipient's domain name. Some combinations of members may be preferred for certain mail systems as determined by the mail system administrator. For example, weakening the OGL key set to consist only of {sender, recipient} helps address the problem of mail server pools, but it is overly broad in that it allows mail for the same sender and recipient pair to come from anywhere on the Internet.

The invention is also directed to a greylisting method utilizing the client host name as a key attribute. The method involves the specific treatment of a key set that uses a client PTR record obtained from the DNS, based on the client IP address of the connected SMTP client, whereby the client PTR record maps an IP address to a client host name. The client PTR record allows for a key set of the form of {trimmed-PTR, sender, recipient}. If the PTR record is not defined, is a multi-homed PTR for multiple domains, or has IP-in-PTR references, the greylisting method uses the client IP address as a fallback value (such as in the conventional OGL method with optimization for already known IP addresses described above).

After determining the client host name and provided the host name is not equivalent to the domain name, then the first label is removed, leaving the client's domain name or a subdomain. If the client host name is the same as the client's domain name, then use the host name unaltered or fallback on using the client's IP address as in the conventional OGL. This trimmed PTR information is then used in placed of the client IP address of the key set, i.e., {trimmed-PTR, sender, recipient}. Greylisting using the trimmed PTR information has the effect of greylisting the sender's pool of mail servers more precisely by domain name or subdomain, instead of by a single machine or subnet. When an SMTP client later retries to send the message and connects to the mail system from a different member of their mail pool, the system locates the cached record for {trimmed-PTR, sender, recipient} and converts the key set to just the {trimmed-PTR} such that future mail from the same group of machines passes through greylisting without delay.

By way of example, consider a sender site including a group of machines such as:

| | |
|---|---|
| out1.pool1.sender.com | 192.0.2.1 |
| out2.pool1.sender.com | 192.0.2.2 |
| out3.pool1.sender.com | 192.0.2.3 |
| out4.pool1.sender.com | 192.0.2.4 |

Using the OGL key set of {client-P, sender, recipient}, the first time the sending site connects, the receiver records in the greylist cache: {192.0.2.3, fred@sender.com, john@receiver.com}, and temporarily rejects the mail. When the sending site retries, a different connecting client IP address (i.e., from a different machine) may be employed such that the receiver records a new key set: {192.0.2.1, fred@sender.com, john@receiver.com}, and once again temporarily rejects the mail. This process can repeat itself for as many times as there are machines in the sending pool of servers, resulting in excessive mail delivery delays and sometimes non-delivery, depending on cache times and retry intervals.

Using the greylisting method of the invention and a configured key set of {trimmed-PTR, sender, recipient}, if the sender connects from IP address 192.0.2.3, which has a PTR of out3.pool1.sender.com, then the receiver uses the trimmed PTR information to record the following key set the first time the sender attempts to deliver the message: {pool1.sender.com, fred@sender.com, john@receiver.com}, and temporarily rejects the message. The next time the sending site connects to the receiver from any machine within the same pool, the trimmed PTR information matches the previously cached record key, which results in the mail being passed through greylisting. The cached key set of the successful sender is then converted to: {pool1.sender.com}, such that all future mail from this pool of mail servers is passed through greylisting without unnecessary delays.

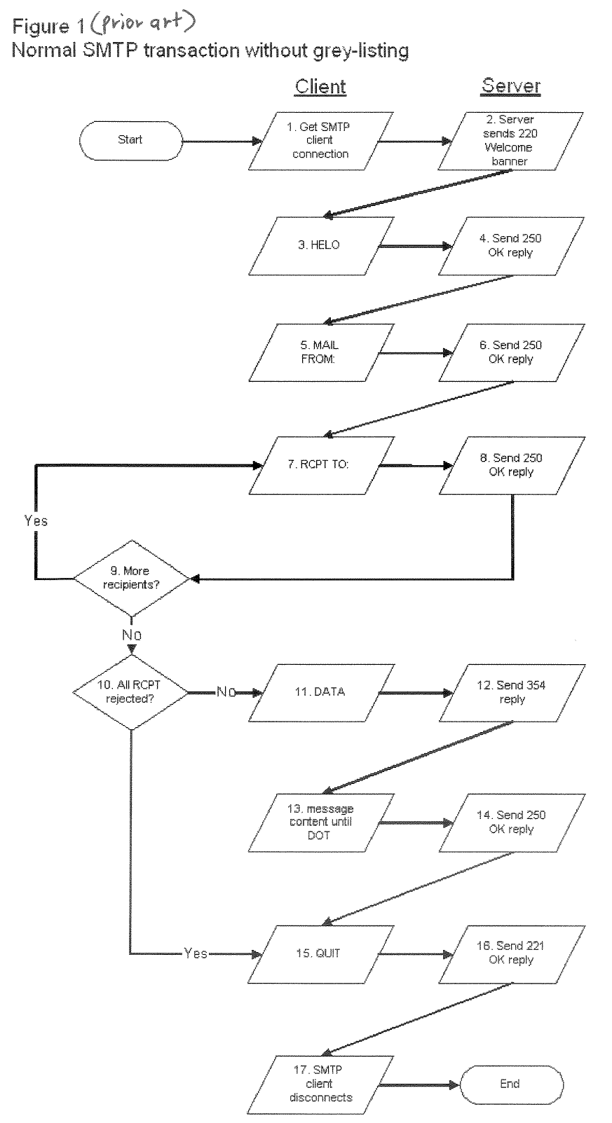

Email systems generally consist of one or more mail servers that accept email submissions, transfer, filter, and store email. Different organizations utilize mail system configurations having different levels of sophistication. Almost all Internet mail make use of RFC 2821 Simple Mail Transfer Protocol (SMTP) to pass messages between mail systems. FIG. 1 (prior art) depicts a logic sequence of an exemplary SMTP transaction between a client and a server without greylisting. In step 1 of the sequence, the client obtains an SMTP client connection, and in response the server sends a 220 Welcome Banner to the client in step 2. Step 3 involves the client sending the HELO or EHLO command to the server, whereas step 4 involves the server sending a 250 OK reply to the client. In step 5, the client sends the MAIL FROM: command to the server, and in response the server sends a 250 OK reply to the client in step 6. Step 7 involves the client sending the RCPT TO: command to the server, while step 8 involves the server sending a 250 OK reply to the client.

With further reference to FIG. 1 (prior art), step 9 involves a determination whether there are additional mail recipients. If so, the sequence returns to step 7, wherein the client sends the next RCPT TO: command to the server. If there are no further recipients, the sequence proceeds to step 10, wherein a determination is made whether all RCPT have been rejected. If so, the sequence proceeds to step 15, wherein the client sends the QUIT command to the server, and in response the server sends a 221 OK reply to the client in step 16. In step 17, the SMTP client disconnects and the logic sequence ends. If in step 10 it is determined that not all RCPT have been rejected, the sequence proceeds to step 11, wherein the DATA command is sent by the client to the server, and in response the server sends a 354 reply to the client in step 14, which invites the client to return the message content. Step 13 involves the client returning the message content until a <CRLF>.<CRLF> sequence is seen as defined by RFC 2821 section 4.1.1.4, whereas step 14 involves the server sending a 250 OK reply to the client. In step 15, the client sends the QUIT command to the server, and in response the server sends a 221 OK reply to the client in step 16. In step 17, the SMTP client disconnects and the logic sequence ends.

RFC 2821 section 4.5.4 sets forth the need for a “mail retry queue”, wherein email is stored until it can be transferred to its destination. Most spam sources send out huge volumes of junk mail and/or virus infected mail. As such, these spam sources do not typically implement mail retry queues, because speed and volume are often more important to them than reliability. A single failed message is unimportant in view of the thousands or millions of messages that are sent.

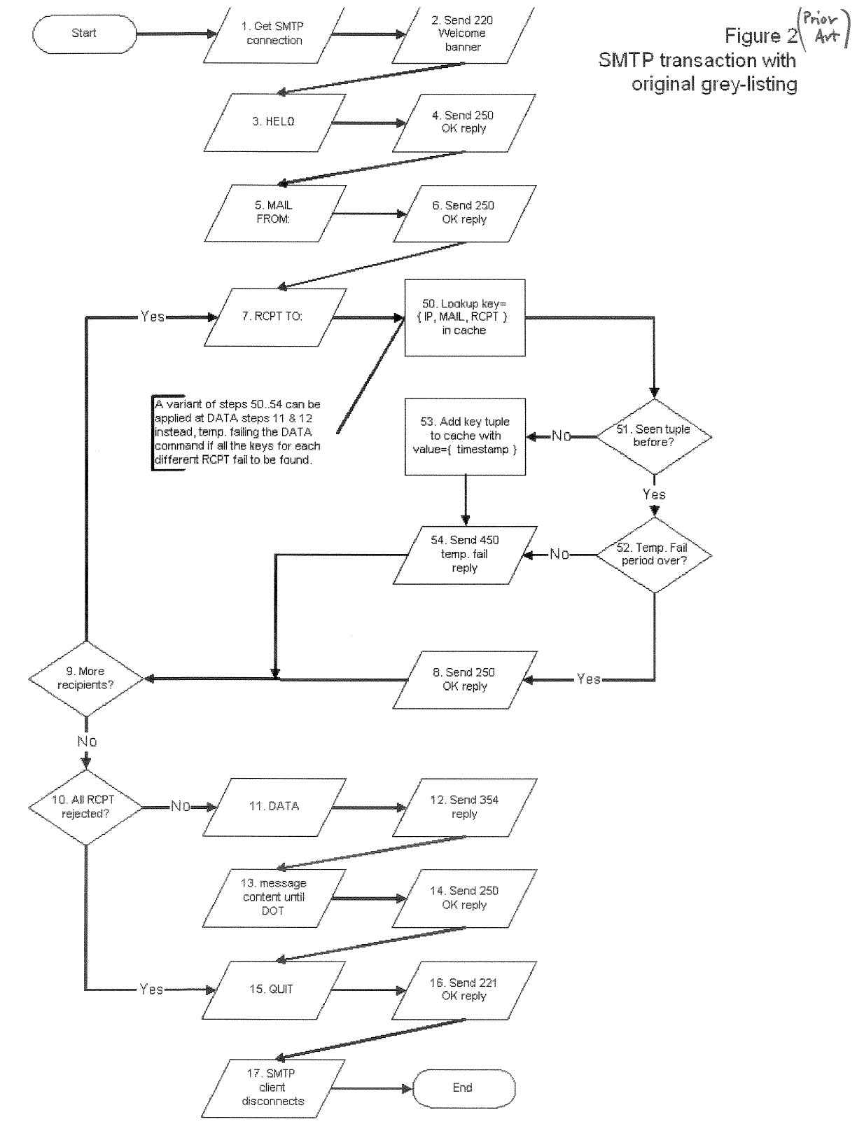

FIG. 2 (prior art) illustrates the logic sequence of the SMTP transaction of FIG. 1, while using the original greylisting method, wherein similar steps have been numbered accordingly. For each RCPT TO: command that the client sends to the server (step 7), the OGL looks up in some storage medium a key set consisting of the {client-IP, sender, recipient} (step 50). If the key set is not found in step 51, then the server adds a new record (step 53) using the key set and a timestamp value of when the record was added. In step 54, the server replies to the RCPT TO: command with a temporary failure result. If the key is found in step 51, but the greylist period has not expired (step 52), then the server replies to the RCPT TO: command with a temporary failure result. In this manner, the greylist period prevents an unknown sender from simply repeating the same RCPT TO: command or disconnecting and immediately reconnecting to try again. Otherwise, if the key is found in step 51 and the greylist period has expired (step 52), then the server replies to the RCPT TO: command with a 250 OK result (step 8), allowing that message to proceed for that sender and recipient pair. In a variant of the OGL method, steps 50 and 54 may be instead applied at DATA steps 11 and 12, temporarily failing the DATA command if all the key sets for each different RCPT fail to be found.

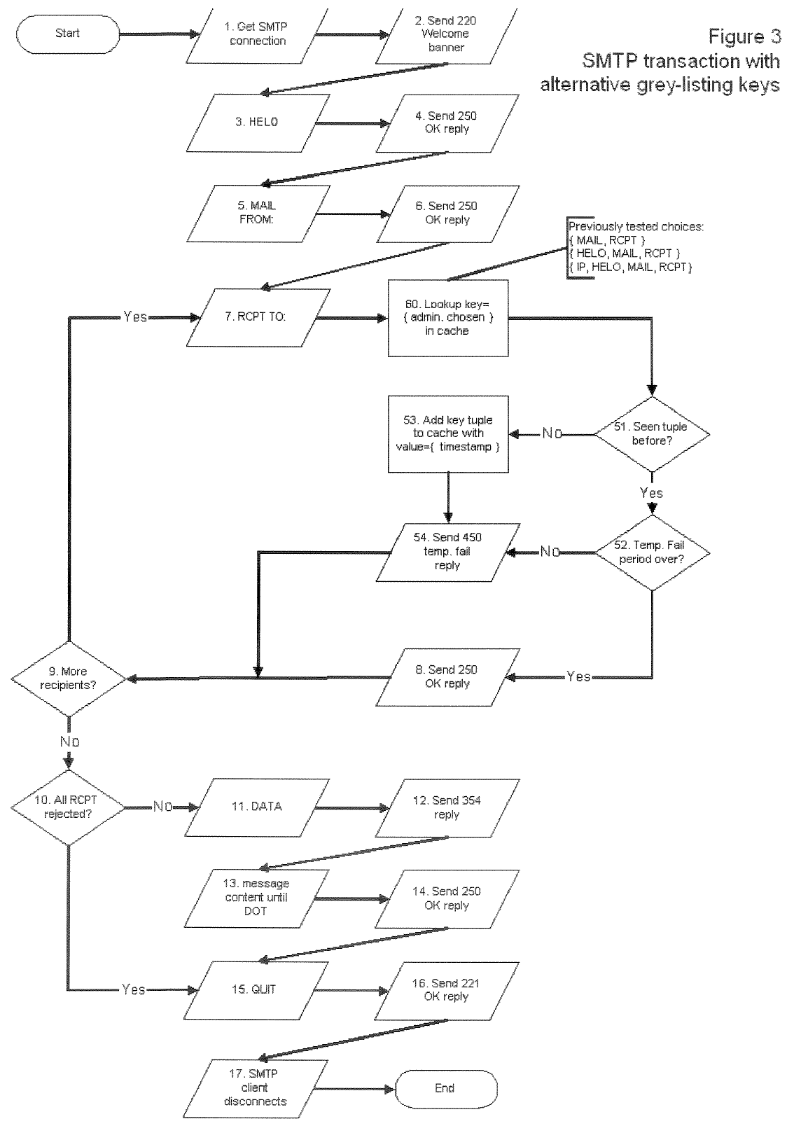

In accordance with the principles of the invention, FIG. 3 illustrates the logic sequence of the SMTP transaction of FIG. 2 using a modified greylisting method, wherein similar steps have been numbered accordingly. The modified greylisting method of the invention features a configurable choice of members used to compose the key set in step 60, which replaces step 50 in the conventional greylisting method. In particular, for each RCPT TO: command that the client sends to the server (step 7), the modified greylisting method looks up a key set having pre-selected members (step 60) in a storage medium. The key set members are derived from the client IP address and/or other SMTP commands used during the SMTP transaction. The client PTR information may be found using a DNS lookup for a PTR record that maps an IP address to a host name. Additional configurable members for use in the key set have been outlined above.

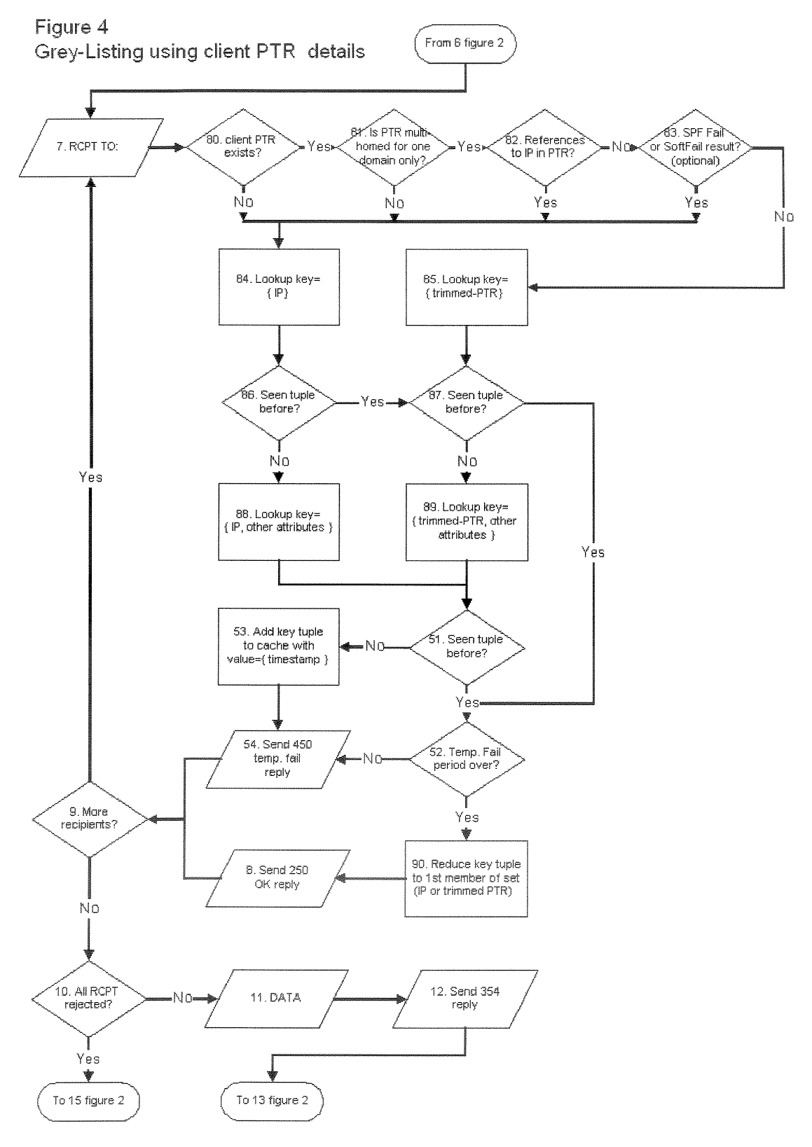

Referring to FIG. 4, in a further implementation of the invention, the client host name is found through a DNS PTR lookup using the client IP address, and is then used as a key set member. FIG. 4 illustrates the logic sequence of the SMTP transaction of FIG. 2 using another modified greylisting method, wherein similar steps have been numbered accordingly. In the illustrated embodiment, steps 80-90 replace step 50 in the conventional greylisting method. Steps 80-83 involve a determination whether the client PTR record exists and is suitable for use. Particularly, step 80 determines whether the client PTR record exists, step 81 determines whether an existing client PTR record is “multi-homed” and the resulting list of host names maps to multiple domain names, and step 82 determines whether the host name is composed from parts of the client IP address typically assigned by ISPs to residential or dynamic IP blocks. Optional step 83 determines whether an SPF check returns a Fail or SoftFail result. If the client PTR record does not exist, or the PTR record is multi-homed, is composed from parts of the client IP address typically assigned to residential or dynamic IP blocks, or (optionally) an SPF check results in a Fail or a SoftFail, the logic sequence proceeds to step 84, and the client IP address is employed as a default value.

If a client PTR record is suitable to use, it is modified by removing the leading label only when the domain name is not used as the host name of a machine. This modification may be referred to herein as “trimming” the PTR record. If a client PTR record does not exist or is not suitable to use, the client IP address is used as a default value. A greylist record lookup is then performed with respect to either the client IP address (step 84) or the trimmed-PTR (step 85). If the record already exists, the sequence proceeds to step 52 to determine whether the record is still within the greylist period. If a record is not found, then the remaining preconfigured members are appended to a key set with the client IP address (step 88) or the trimmed PTR (step 89) as one of the members. The use of the trimmed-PTR information in steps 85 and 89 allows the identification of a group of mail servers by a common domain or subdomain name, thereby avoiding unnecessary delays in mail delivery.

From this point in the logic sequence, the remaining steps are identical to that of FIG. 2, except for the addition of step 90 after step 52. In particular, if the greylist period is determined to be over in step 52, the sequence proceeds to step 90 wherein the key set is reduced to a key set containing only one member, which is either the client IP address or trimmed-PTR. Step 90, in conjunction with steps 84 and 85, allows greylisting to be skipped once an SMTP client has demonstrated the existence of a retry queue, thereby avoiding unnecessary delays when any of the other members of the key set change (i.e., other than the client IP address or trimmed-PTR). The other members of the key set may, for example, help identify a machine or group of machines and a conversation. However, once the SMTP client has shown that it employs a mail retry queue, the other members of the key set hinder more than help the process of greylisting.

It will be apparent to one of skill in the art that the steps outlined by FIG. 4. could be applied in response to the SMTP DATA command instead of the RCPT TO: command. If the preselected key set does not contain a recipient member or members derived from a recipient, then the method is the same as above. Otherwise, the method is repeated for each recipient, replying CONTINUE to the DATA command for the first key set that is found and has passed the predetermined greylist period. If all the key sets have failed to be found or have not yet passed the predetermined greylist period, only then is a temporary failure result sent in response to the DATA command.

The greylisting technology of the invention may be applied to any number of alternative messaging protocols and message formats other than SMTP and the Internet Message Format. For example, the greylisting technology may be used in conjunction with the SMS protocol such that text messages to mobile phones are subjected to greylisting in accordance with the principles of the invention. In addition, the greylisting technology may be used in conjunction with messaging protocols including, but not limited to, simple network paging protocol (SNPP), wireless communication transfer protocol (WCTP), multimedia message service (MMS), Wireless Village, and any other messaging protocol designed for the transfer of messages between two machines/locations.

As used herein, the term “network” refers to any configuration of data processing devices and software connected for information interchange. For example, the network may comprise the Internet, an intranet, a local area network (LAN), a wide area network (WAN), a virtual private network (VPN), an internetwork, a personal area network (PAN), a campus area network (CAN), a metropolitan area network (MAN), or any other configuration of data processing devices and software connected for information interchange.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

1. A greylisting record for an SMTP client, comprising:
SMTP client network information derived from an email transaction including an IP address of the client and connection details; and
SMTP command arguments in whole or in part.

2. The greylisting record of claim 1, wherein the connection details are selected from the group consisting of client IP address, client IP subnet, client PTR records, NS records, passive OS finger-printing, AS numbers, and WHOIS data.

3. The greylisting record of claim 1, wherein a MAIL FROM: argument in the email transaction includes information selected from the group consisting of MX records, NS records, TXT records, and WHOIS data.

4. The greylisting record of claim 1, wherein the SMTP command arguments are selected from the group consisting of the HELO or EHLO argument, AUTH arguments, STARTTLS certificate details, the MAIL FROM: argument and its parameters, and the RCPT TO: argument and its parameters.

5. The greylisting record of claim 1, wherein the greylisting record is stored and retrieved as a configurable combination of key set members related to known and/or derivable details of the email transaction.

6. The greylisting record of claim 5, wherein the configured key set is not the set {client IP address, MAIL FROM: address, RCPT TO: address}.

7. The greylisting record of claim 5, wherein the configured key set is neither the {client-IP} nor the {client IP subnet} sets.

8. The greylisting record of claim 1, wherein the greylisting record permits mail server pools sharing a common mail queue to be identified and greylisted only once.

9. The greylisting record of claim 1, wherein the greylisting record allows email systems that have demonstrated the use of a mail retry queue to avoid subsequent delays of future email having different email characteristics.

10. A method for greylisting a message of an SMTP transaction in response to a RCPT TO: command from an SMTP client, comprising the steps of:
(a) looking up in a storage medium a key set having pre-selected members;
(b) if the key set is not found, adding a new record comprising the key set and a timestamp value of when the record was added, and then reporting a temporarily failure to the RCPT TO: command;
(c) replying to the RCPT TO: command with a temporary failure result if the key set is found in step (a) and the predetermined greylist period has not expired; and
(d) replying to the RCPT TO: command with an OK result if the key set is found in step (a) and the predetermined greylist period has expired.

11. The method of claim 10, wherein the key set members are derived from a client IP address and/or other SMTP commands used during the SMTP transaction.

12. The method of claim 11, wherein the key set members derived from the client IP address are selected from the group consisting of the client IP address, client IP subnet, client PTR records, NS records, passive OS finger-printing, AS numbers, and WHOIS data.

13. The method of claim 11, wherein the key set members are selected from the group consisting of, the HELO or EHLO argument, the arguments of an AUTH command, STARTTLS certificate details, the arguments and parameters of the MAIL FROM: command, and the arguments and parameters of the RCPT TO: command.

14. The method of claim 13, wherein the parameters specified with the MAIL FROM: command comprise a SIZE command or an AUTH command, in addition to a sender address.

15. A method for greylisting a message of an SMTP transaction in response to a RCPT TO: command from an SMTP client, comprising the steps of:
(a) determining whether a client PTR record exists and is suitable for use;
(b) if the client PTR record exists and is suitable to use, trimming the client PTR record by removing a leading label when a domain name of the client PTR record is not used as a host name of a machine, and otherwise using the client IP address as a default value;
(c) looking up in a storage medium a key set containing only the {trimmed PTR record} or the {client IP address};
(d) if a result from step (c) is found, continue at step (g);
(e) looking up in a storage medium a key set containing the trimmed PTR record or the client IP address in addition to other preselected members;
(f) if the key set is not found, adding a new record comprising a key set and a timestamp value of when the record was added, then replying to the RCPT TO: command with a temporary failure result;
(g) replying to the RCPT TO: command with a temporary failure result if a key set is found in steps (c) or (e) and the predetermined greylist period has not expired; and
(h) when a key set is found and the predetermined greylist period has expired, reducing the key set to the {client IP address} set or the {trimmed PTR} set, and replying to the RCPT TO: command with an OK result.

16. The method of claim 15, wherein the client PTR record is not suitable for use if it is multi-homed and the resulting list of host names maps to multiple different domain names.

17. The method of claim 15, wherein the client PTR record is not suitable for use if the host name is composed from parts of the client IP address typically assigned by ISPs to residential or dynamic IP blocks.

18. The method of claim 15, wherein the client PTR record is not suitable for use if an SPF check results in a Fail or a SoftFail result.

19. The method of claim 15, wherein trimming the PTR record permits an identification of a group of mail servers by a common domain or subdomain name.

20. The method of claim 15, wherein the trimmed PTR record is one of the members of the key set.

21. A method for greylisting a message of an SMTP transaction in response to a DATA command from an SMTP client, comprising the steps of:
(a) looking up in a storage medium a key set having pre-selected members;
(b) if the key set is not found, adding a new record comprising the key set and a timestamp value of when the record was added, and then reporting a temporarily failure to the DATA command;
(c) replying to the DATA command with a temporary failure result if the key set is found in step (a) and the predetermined greylist period has not expired; and
(d) replying to the DATA command with a CONTINUE result if the key set is found in step (a) and the predetermined greylist period has expired.

22. The method of claim 21, wherein the key set members are derived from a client IP address and/or other SMTP commands used during the SMTP transaction.

23. The method of claim 22, wherein the key set members derived from the client IP address are selected from the group consisting of the client IP address, client IP subnet, client PTR records, NS records, passive OS finger-printing, AS numbers, and WHOIS data.

24. The method of claim 22, wherein the key set members are selected from the group consisting of, the HELO or EHLO argument, the arguments of an AUTH command, STARTTLS certificate details, the arguments and parameters of the MAIL FROM: command, and the arguments and parameters of the RCPT TO: command.

25. The method of claim 24, wherein the parameters specified with the MAIL FROM: command comprise a SIZE command or an AUTH command, in addition to a sender address.

26. A method for greylisting a message of an SMTP transaction in response to a DATA command from an SMTP client, comprising the steps of:
(a) determining whether a client PTR record exists and is suitable for use;
(b) if the client PTR record exists and is suitable to use, trimming the client PTR record by removing a leading label when a domain name of the client PTR record is not used as a host name of a machine, and otherwise using the client IP address as a default value;
(c) looking up in a storage medium a key set containing only the {trimmed PTR record} or the {client IP address};
(d) if a result from step (c) is found, continue at step (g);
(e) looking up in a storage medium a key set containing the trimmed PTR record or the client IP address in addition to other preselected members;
(f) if the key set is not found, adding a new record comprising a key set and a timestamp value of when the record was added, then replying to the DATA command with a temporary failure result;
(g) replying to the DATA command with a temporary failure result if a key set is found in steps (c) or (e) and the predetermined greylist period has not expired; and
(h) when a key set is found and the predetermined greylist period has expired, reducing the key set to the {client IP address} set or the {trimmed PTR} set, and replying to the DATA command with a CONTINUE result.

27. The method of claim 26, wherein the client PTR record is not suitable for use if it is multi-homed and the resulting list of host names maps to multiple different domain names.

28. The method of claim 26, wherein the client PTR record is not suitable for use if the host name is composed from parts of the client IP address typically assigned by ISPs to residential or dynamic IP blocks.

29. The method of claim 26, wherein the client PTR record is not suitable for use if an SPF check results in a Fail or a SoftFail result.

30. The method of claim 26, wherein trimming the PTR record permits an identification of a group of mail servers by a common domain or subdomain name.

31. The method of claim 26, wherein the trimmed PTR record is one of the members of the key set.
